(19) United States
(12) Patent Application Publication
(10) Pub. No.: US 2026/0029799 A1
(43) Pub. Date: Jan. 29, 2026

(54) Cleaning Robot

(71) Applicant: Anker Innovations Technology Co., Ltd., Changsha (CN)

(72) Inventors: Xu Yang, Shenzhen (CN); Junchao Yang, Shenzhen (CN)

(21) Appl. No.: 19/269,577

(22) Filed: Jul. 15, 2025

(30) Foreign Application Priority Data
Jul. 23, 2024 (CN) 202410993632.6

(51) Int. Cl. G05D 1/639; A47L 11/40; G05D 105/10

(52) U.S. Cl. CPC G05D 1/639; A47L 11/4011; A47L 11/4041; A47L 11/4072; A47L 2201/04; G05D 2105/10

(57) ABSTRACT

A cleaning robot may include a body, a driving wheel, and a cleaning member. The driving wheel and the cleaning member may be installed on and rotatably connected with the body. The cleaning robot may have a backward obstacle-crossing mode and a forward obstacle-crossing mode. In the forward obstacle-crossing mode, a head of the cleaning robot may face an obstacle, the driving wheel may rotate forward, and the cleaning member may rotate in the same or in an opposite direction to the rotation of the driving wheel. In the backward obstacle-crossing mode, a tail of the cleaning robot may face the obstacle, the driving wheel may rotate reversely, and a rotation direction of the cleaning member may be the same as or opposite to the rotation direction of the cleaning member in the forward obstacle-crossing mode.

### CROSS REFERENCE TO RELATED APPLICATION

The present application claims priority to Chinese Patent Application No. 202410993632.6, filed on Jul. 23, 2024, which is herein incorporated by reference by its entirety.

### FIELD

The present disclosure relates to the technical field of smart home devices, in particular to a cleaning robot.

### BACKGROUND

One development of smart home technology may be the advent of cleaning robots, which can automatically clean spaces such as indoor spaces.

Currently, during a cleaning task of a cleaning robot, it may be common for the cleaning robot to enter a sunken area or cross a door sill. This circumstance often requires crossing an obstacle. For example, it may be a common obstacle-crossing circumstance for the cleaning robot to cross from a living room to a balcony.

However, based on a driving mode, a self-weight, a design structure, and other factors of a cleaning robot, the cleaning robot usually has a certain upper limit of obstacle-crossing ability. If an obstacle-crossing ability required by the obstacle-crossing scenario exceeds or approaches the upper limit of the obstacle-crossing ability of the cleaning robot, the cleaning robot to may be trapped (e.g., because of an obstacle-crossing failure).

### SUMMARY

Aspects described herein improve, among other things, an obstacle-crossing success rate of cleaning robots.

Aspects described herein provide a cleaning robot including a body, a driving wheel, and/or a cleaning member. Both the driving wheel and the cleaning member may be installed on the body and may be rotatably connected with the body, a rotating shaft of the driving wheel may be parallel to a rotating shaft of the cleaning member, and/or the cleaning robot at least has a backward obstacle-crossing mode and a forward obstacle-crossing mode. In the forward obstacle-crossing mode, a head of the cleaning robot may face an obstacle, the driving wheel may rotate forward, and the cleaning member may rotate in a first direction which may be the same as or opposite to the rotation direction of the driving wheel; and in the backward obstacle-crossing mode, a tail of the cleaning robot may face the obstacle, the driving wheel may rotate reversely, and a rotation direction of the cleaning member may be the same as or opposite to the rotation direction of the cleaning member in the forward obstacle-crossing mode.

The cleaning member may comprise a rolling brush configured for dry cleaning of a surface (e.g., a working surface, such as a floor, carpet). In the forward obstacle-crossing mode, the rolling brush may rotate forward. In the backward obstacle-crossing mode, the rolling brush may rotate forward or reversely. Additionally and/or alternatively, in the forward obstacle-crossing mode, the rolling brush may rotate reversely, and in the backward obstacle-crossing mode, the rolling brush may rotate reversely.

The cleaning member may comprise a roller configured for wet cleaning of a surface. In the forward obstacle-crossing mode, the roller may rotate forward or reversely; and in the backward obstacle-crossing mode, the roller may rotate reversely.

The forward obstacle-crossing mode may comprise a normal obstacle-crossing mode and a strong obstacle-crossing mode. The cleaning member may comprise a rolling brush or a roller, the rolling brush may be configured for dry cleaning of a surface, and the roller may be configured for wet cleaning of a surface. In the normal obstacle-crossing mode, the cleaning member may rotate reversely, and in the strong obstacle-crossing mode, the cleaning member may rotate forward. Additionally and/or alternatively, the cleaning member may comprise the rolling brush and the roller, and the number of forward rotations of the rolling brush and the roller in the strong obstacle-crossing mode may be greater than the number of forward rotations thereof in the normal obstacle-crossing mode.

The cleaning robot further may comprise a processor separately connected with the driving wheel and the cleaning member. The processor may be configured to output a control instruction to the driving wheel and the cleaning member according to a target obstacle-crossing mode. The target obstacle-crossing mode may comprise the backward obstacle-crossing mode or the forward obstacle-crossing mode, and the forward obstacle-crossing mode may comprise a normal obstacle-crossing mode and a strong obstacle-crossing mode. The number of forward rotations of the driving wheel and the cleaning member in the strong obstacle-crossing mode may be greater than that in the normal obstacle-crossing mode. The driving wheel and the cleaning member may be configured to perform a rotation operation according to the control instruction.

The processor may be further configured to select the target obstacle-crossing mode from pre-configured obstacle-crossing modes according to the attribute information of the obstacle, the pre-configured obstacle-crossing modes comprising the backward obstacle-crossing mode, the normal obstacle-crossing mode and the strong obstacle-crossing mode.

The processor may be further configured to take the normal obstacle-crossing mode among the pre-configured obstacle-crossing modes as the target obstacle-crossing mode in a case where the attribute information meets information conditions corresponding to the normal obstacle-crossing mode. The processor may be further configured to take the backward obstacle-crossing mode or the strong obstacle-crossing mode as the target obstacle-crossing mode based on the attribute information and scenario complexity of an obstacle-crossing scenario where the cleaning robot may be located in a case where the attribute information does not meet information conditions corresponding to the normal obstacle-crossing mode.

The processor may be further configured to, in a case where the scenario complexity meets preset conditions, take the backward obstacle-crossing mode as the target obstacle-crossing mode when the attribute information meets information conditions corresponding to the backward obstacle-crossing mode; and take the strong obstacle-crossing mode as the target obstacle-crossing mode when the attribute information does not meet information conditions corresponding to the backward obstacle-crossing mode.

The processor may be further configured to send a mode selection request to a terminal device in a case where the scenario complexity does not meet preset conditions; and take the backward obstacle-crossing mode or the strong obstacle-crossing mode as the target obstacle-crossing mode based on a user's response information to the mode selection request.

The processor may be further configured to obtain the number of consecutive failures in obstacle-crossing of the cleaning robot during a process in which the cleaning robot crosses the obstacle in the normal obstacle-crossing mode; take the backward obstacle-crossing mode or the strong obstacle-crossing mode as a new target obstacle-crossing mode if the number of consecutive failures in obstacle crossing may be greater than a first failure number threshold; and control the cleaning robot to cross the obstacle in the new target obstacle-crossing mode.

The processor may be further configured to obtain the number of consecutive failures of the cleaning robot in crossing an obstacle in an obstacle-crossing mode with the strongest obstacle-crossing ability; and control the cleaning robot to enter the standby state and send an obstacle-crossing failure message if the number of consecutive failures may be greater than a second failure number threshold.

The processor may be further configured to calculate an obstacle-crossing failure probability in a pre-configured obstacle-crossing mode according to the number of consecutive failures in obstacle-crossing of the cleaning robot; and update information conditions corresponding to the pre-configured obstacle-crossing mode according to the obstacle-crossing failure probability, the information conditions corresponding to the pre-configured obstacle-crossing mode being configured to characterize obstacle-crossing ability of the cleaning robot in different obstacle-crossing modes.

The processor may be further configured to send an obstacle-crossing request and receive request response information fed back based on the obstacle-crossing request in a case where the cleaning robot fails to cross an obstacle in an obstacle-crossing mode with strongest obstacle-crossing ability; and control the cleaning robot to cross the obstacle in the obstacle-crossing mode with the strongest obstacle crossing ability or control the cleaning robot to enter a standby state according to the request response information.

Aspects described herein also provide a computer-readable storage medium with a computer program stored thereon, and the computer program, when executed by a processor, implements a method for the cleaning robot to cross obstacles.

Aspects described herein also provide a computer program product including a computer program which, when executed by a processor, implements a method for the cleaning robot to cross obstacles.

The cleaning robot may comprise a body, a driving wheel and/or a cleaning member. Both the driving wheel and the cleaning member may be installed on the body and may be rotatably connected with the body, a rotating shaft of the driving wheel may be parallel to a rotating shaft of the cleaning member, and/or the cleaning robot at least has a backward obstacle-crossing mode and a forward obstacle-crossing mode. In the forward obstacle-crossing mode, a head of the cleaning robot faces an obstacle, the driving wheel may rotate forward, and the cleaning member may rotate in a first direction which may be the same as or opposite to the rotation direction of the driving wheel; and in the backward obstacle-crossing mode, a tail of the cleaning robot faces the obstacle, the driving wheel may rotate reversely, and a rotation direction of the cleaning member may be the same as or opposite to the rotation direction of the cleaning member in the forward obstacle-crossing mode. By switching the orientation of the cleaning robot to the obstacle, the obstacle-crossing modes may include the forward obstacle-crossing mode and the backward obstacle-crossing mode. Moreover, in the forward obstacle-crossing mode and the backward obstacle-crossing mode, by setting the rotation directions of the driving wheel and the cleaning member, crossing can be performed with different driving forces and speeds in crossing the obstacle. In turn, the cleaning robot can cross obstacles of different difficulties in different obstacle-crossing modes, which may further improve the obstacle-crossing ability of the cleaning robot and ensures the obstacle-crossing success rate of the cleaning robot.

### BRIEF DESCRIPTION OF THE DRAWINGS

Drawings used in description of the examples or the related art are briefly introduced below. The accompanying drawings described below may be merely some examples of the present disclosure.

FIG. 1 may be a side view of a structure of a cleaning robot;

FIG. 2 may be a bottom view of a structure of a cleaning robot;

FIG. 3 may be a bottom view of a structure of a cleaning robot;

FIG. 4 may be a bottom view of a structure of a cleaning robot; and

FIG. 5 may be an internal structure diagram of a computer device in a cleaning robot.

### DESCRIPTION OF REFERENCE NUMERALS

10: Cleaning Robot; 11: Body; 12: Driving wheel; 13: Cleaning Member; 131: Rolling Brush; 132: Roller; 14: Processor; 20: Obstacle.

### DETAILED DESCRIPTION

The present disclosure will be described in detail with reference to the accompanying drawings and examples. The examples described here do not limit the present disclosure.

Generally, a main task of a cleaning robot may be to clean a floor. Therefore, the cleaning robot has a normal cleaning mode when leaving factory. In the normal cleaning mode, the cleaning robot can clean the floor. At this time, a driving wheel of the cleaning robot may rotate forward, and the cleaning member can rotate forward or reversely according to actual designs of different cleaning robots.

During a cleaning task performed by the cleaning robot, it may be a common scenario to meet a sunken area or cross a door sill, for example, an obstacle-crossing scenario. For example, it may be a common obstacle-crossing scenario for the cleaning robot in a home environment to cross from a living room to a balcony.

For a simple obstacle-crossing scenario, the cleaning robot can cross an obstacle in the obstacle-crossing scenario in the normal cleaning mode. However, based on a driving mode, a self-weight, a design structure and other factors of the cleaning robot, the cleaning robot usually has a certain upper limit of obstacle-crossing ability. If obstacle-crossing ability required by the obstacle-crossing scenario exceeds or approaches the upper limit of the obstacle-crossing ability of the cleaning robot, the cleaning robot on one hand may be prone to be trapped because of obstacle-crossing failure, with a low obstacle-crossing success rate of the cleaning robot; and the cleaning robot on the other hand may be prone to try to cross the obstacle many times before succeeding, with low obstacle-crossing efficiency of the cleaning robot.

Aspects described herein relate to a cleaning robot that addresses those and other problems. The cleaning robot can have ability to cross various obstacles of different difficulties in the normal cleaning mode by switching an orientation of the cleaning robot to the obstacle and adjusting rotation directions of a driving wheel and a cleaning member, and thus a success rate of crossing obstacles can be improved. The technical solutions provided in the examples of the present disclosure are not limited to only solve the above-described problem, but may also have other technical effects, and details thereof can refer to the following description of examples.

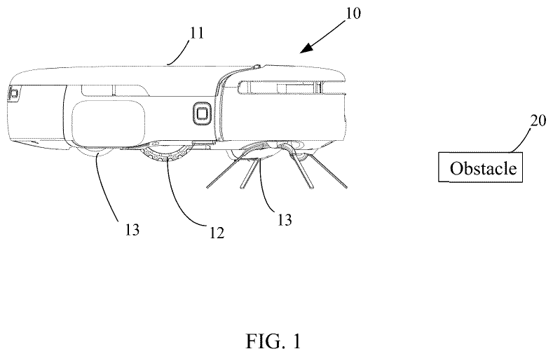

As shown in FIG. 1, a cleaning robot 10 may be provided, which may comprise a body 11, a driving wheel 12 and/or a cleaning member 13. Both the driving wheel 12 and the cleaning member 13 may be installed on the body 11 and may be rotatably connected with the body 11, and a rotating shaft of the driving wheel 12 may be parallel to a rotating shaft of the cleaning member 13, and the cleaning robot 10 at least has a backward obstacle-crossing mode and a forward obstacle-crossing mode.

In the forward obstacle-crossing mode, a head of the cleaning robot 10 may face an obstacle 20, the driving wheel 12 may rotate forward, and the cleaning member 13 may rotate in a first direction which may be the same as or opposite to a rotation direction of the driving wheel 12.

In the backward obstacle-crossing mode, a tail of the cleaning robot 10 faces the obstacle 20, and the driving wheel 12 may rotate reversely, and a rotation direction of the cleaning member 13 may be the same as or opposite to that in the forward obstacle-crossing mode.

The cleaning robot 10 has a wide range of application scenarios, including home environment, office premises, commercial premises, and/or many other fields. For any of the scenarios, the cleaning robot 10 may be capable of sweeping and/or mopping the floor.

For the cleaning robot 10 with a cleaning function, the cleaning member 13 in the cleaning robot 10 may refer to a rolling brush 131, and the rolling brush 131 may be used for dry cleaning of a surface, and the dry cleaning may refer to cleaning garbage on the floor without wetting the floor. During movement of the cleaning robot 10 driven by the driving wheel 12, the rolling brush 131 may sweep the floor. For a cleaning robot 10 which only has a function of mopping the floor, the cleaning member 13 in the cleaning robot 10 may refer to a roller 132, and the roller 132 may be used for wet cleaning of the surface, and the wet cleaning may refer to cleaning the floor with the wet roller 132. During movement of the cleaning robot 10 driven by the driving wheel 12, the roller 132 may mop the floor. For a cleaning robot 10 incorporating sweeping and mopping, the cleaning member 13 in the cleaning robot 10 may comprise the rolling brush 131 and the roller 132. During movement of the cleaning robot 10 driven by the driving wheel 12, the rolling brush 131 disposed in the front may sweep the floor and the roller 132 disposed in the rear may mop the floor. It should be noted that for the cleaning robot 10 incorporating sweeping and mopping, the roller 132 for mopping can also be other types of mops, such as mops with a rotation axis perpendicular to the floor or a tiled mops.

The cleaning robot 10 can include obstacle-crossing modes with various obstacle-crossing abilities to ensure that the cleaning robot 10 can cross obstacles 20 of different difficulties. The obstacle-crossing modes with various obstacle-crossing abilities may be mainly determined by an orientation of the cleaning robot 10 to the obstacle 20 and rotation directions of the driving wheel 12 and the cleaning member 13.

Taking the head of the cleaning robot 10 facing the obstacle 20 as an example, the driving wheel 12 of the cleaning robot 10 may rotate forward, and the head of the cleaning robot 10 moves toward the obstacle 20 when crossing the obstacle 20. In this case, the rotation direction of the cleaning member 13 determines movement power of the cleaning robot 10.

The cleaning member 13 may comprise one of the rolling brush 131 and the roller 132. The cleaning member 13 of the cleaning robot 10 may rotate forward in the normal cleaning mode, and the cleaning member 13 continues rotating forward when the cleaning robot 10 crosses an obstacle. If the cleaning member 13 of the cleaning robot 10 may rotate reversely in the normal cleaning mode, the cleaning member 13 can maintain reverse rotation when the cleaning robot 10 faces an obstacle 20 of lower difficulty to cross during obstacle-crossing. However, when facing the obstacle 20 of higher difficulty to cross, the cleaning member 13 can be switched to rotate forward, so as to provide greater forward movement power for the cleaning robot 10.

If the cleaning member 13 of the cleaning robot 10 may comprise the rolling brush 131 and the roller 132 and both the rolling brush 131 and the roller 132 rotate forward in the normal cleaning mode, both the rolling brush 131 and the roller 132 maintain forward rotation when the cleaning robot 10 crosses an obstacle, so that driving power of the cleaning robot 10 may be strongest and the cleaning robot 10 can cross the obstacle 20 the most difficult to cross. If one of the rolling brush 131 and the roller 132 may rotate forward and the other of the rolling brush and the roller may rotate reversely in the normal cleaning mode, the rolling brush 131 and the roller 132 can maintain their rotation directions in the normal cleaning mode when the cleaning robot 10 faces the obstacle 20 of lower difficulty to cross during obstacle-crossing, but both of the rolling brush 131 and the roller 132 can rotate forward when the cleaning robot 10 faces the obstacle 20 higher difficulty to cross. If both the rolling brush 131 and the roller 132 rotate reversely in the normal cleaning mode, the rolling brush 131 and the roller 132 can maintain their rotation directions in the normal cleaning mode, for example, maintain reverse rotation; or can change a rotation direction of one of them, for example, one of the rolling brush 131 and the roller 132 may maintain reverse rotation and the other of them may be switched to rotate forward when the cleaning robot 10 faces the obstacle 20 of lower difficulty to cross during obstacle-crossing. However, both the rolling brush 131 and the roller 132 can be switched to rotate forward when facing the obstacle 20 of higher difficulty to cross.

In the forward obstacle-crossing mode, the cleaning robot 10 can select an appropriate obstacle-crossing mode such as a normal obstacle-crossing mode and a strong obstacle-crossing mode according to an actual design of the cleaning member 13 and an actual situation of the obstacle 20 to be crossed, such as a type, height and width of the obstacle 20. A rotation direction of the cleaning member 13 in the normal obstacle-crossing mode may be the same as that in the normal cleaning mode. The number of forward rotations of the cleaning member 13 and the driving wheel 12 in the strong obstacle-crossing mode may be greater than that of the cleaning member 13 and the driving wheel 12 in the normal cleaning mode, so that compared with the normal obstacle-crossing mode, the cleaning robot 10 in the strong obstacle-crossing mode has stronger forward movement power and can cross the obstacle 20 of higher difficulty to cross.

Taking the tail of the cleaning robot 10 facing the obstacle 20 as an example, the driving wheel 12 of the cleaning robot 10 may rotate reversely, and the tail of the cleaning robot 10 moves toward the obstacle 20 when crossing the obstacle 20. In this case, the rotation direction of the cleaning member 13 determines obstacle-crossing power of the cleaning robot 10.

If the cleaning member 13 may comprise one of the rolling brush 131 and the roller 132 and the cleaning member 13 of the cleaning robot 10 rotate reversely in the normal cleaning mode, the cleaning member 13 can continue rotating reversely when the cleaning robot 10 crosses an obstacle. If the cleaning member 13 of the cleaning robot 10 rotates forward in the normal cleaning mode, the cleaning member 13 can maintain forward rotation when the cleaning robot 10 faces the obstacle 20 of lower difficulty to cross in obstacle-crossing. When facing the obstacle 20 of higher difficulty to cross, the cleaning member 13 can be switched to reverse reversely, so as to provide greater obstacle-crossing power for the cleaning robot 10.

If the cleaning member 13 of the cleaning robot 10 may comprise the rolling brush 131 and the roller 132 and both of the rolling brush 131 and the roller 132 rotate reversely in the normal cleaning mode, the rolling brush 131 and the roller 132 maintains reverse rotation when the cleaning robot 10 crosses an obstacle, so that driving power of the cleaning robot 10 may be strongest and the cleaning robot 10 can cross obstacles 20 of higher difficulty. If one of the rolling brush 131 and the roller 132 rotates forward and the other of the rolling brush 131 and the roller 132 rotates reversely in the normal cleaning mode, the rolling brush 131 and the roller 132 can maintain their rotation directions in the normal cleaning mode when the cleaning robot 10 faces the obstacle 20 of lower difficulty to cross during obstacle-crossing, but both of the rolling brush 131 and the roller 132 can rotate reversely when the cleaning robot faces the obstacle 20 of higher difficulty to cross. If both the rolling brush 131 and the roller 132 rotate forward in the normal cleaning mode, the rolling brush 131 and the roller 132 can maintain their rotation directions in the normal cleaning mode, for example, can both maintain forward rotation; or can be change the rotation direction of one of them, for example, one of the rolling brush 131 and the roller 132 maintains forward rotation and the other of them may be switched to rotate reversely when the cleaning robot 10 faces the obstacle 20 of lower difficulty to cross during obstacle-crossing. Both the rolling brush 131 and the roller 132 can be switched to rotate reversely when facing the obstacle 20 of higher difficulty to cross.

The cleaning robot 10 can choose the backward obstacle-crossing mode or the forward obstacle-crossing mode according to the design of the cleaning member 13 and the actual situation of the obstacle 20 to be crossed, such as the type, height and width of the obstacle 20. For example, the cleaning robot 10 may comprise the rolling brush 131 and the roller 132, and the rolling brush 131 may rotate forward and the roller 132 may rotate reversely in the normal cleaning mode. Changing the rotation directions of the rolling brush 131 and the roller 132 may cause the cleaning robot 10 to spit garbage and dirt, and the cleaning robot 10 may be prone to head up since a center of gravity thereof may be at the back in the forward obstacle-crossing mode, both of which may result in a low probability of the cleaning robot 10 successfully crossing obstacles in the forward obstacle-crossing mode. Therefore, for the cleaning robot 10 of this example, the backward obstacle-crossing mode may be preferred, for example, the cleaning robot 10 turns round by 180 degrees, so that the tail of the cleaning robot faces the obstacle 20 and the driving wheel 12 may be controlled to rotate reversely while the rolling brush 131 maintains forward rotation and the roller 132 maintains reverse rotation, thus improving an obstacle-crossing success rate. Of course, in other examples, the cleaning robot 10 can design related structures to prevent garbage and dirt spitting, so that the cleaning robot 10 has more choices in crossing obstacles.

Both of the forward rotation and the reverse rotation described above refer to the rotation direction of the driving wheel 12 when the cleaning robot 10 moves forward. When the cleaning robot 10 moves forward, the driving wheel 12 may rotate forward, a direction of the forward rotation may be the same as the rotation direction of the driving wheel 12 when moving forward, and a direction of the reverse rotation may be opposite to the rotation direction of the driving wheel 12 when moving forward.

The cleaning robot 10 may comprise a body 11, a driving wheel 12 and a cleaning member 13. Both the driving wheel 12 and the cleaning member 13 may be installed on the body 11 and may be rotatably connected with the body 11, and a rotating shaft of the driving wheel 12 may be parallel to a rotating shaft of the cleaning member 13, and the cleaning robot 10 may have a backward obstacle-crossing mode and a forward obstacle-crossing mode. In the forward obstacle-crossing mode, a head of the cleaning robot 10 may face an obstacle 20, the driving wheel 12 may rotate forward, and the cleaning member 13 may rotate in a first direction which may be the same as or opposite to a rotation direction of the driving wheel 12. In the backward obstacle-crossing mode, a tail of the cleaning robot 10 may face the obstacle 20, and the driving wheel 12 may rotate reversely, and a rotation direction of the cleaning member 13 may be the same as or opposite to that in the forward obstacle-crossing mode. By switching the orientation of the cleaning robot 10 to the obstacle 20, the obstacle-crossing modes may include the forward obstacle-crossing mode and the backward obstacle-crossing mode. Moreover, in the forward obstacle-crossing mode and the backward obstacle-crossing mode, by setting the rotation directions of the driving wheel 12 and the cleaning member 13, crossing can be performed with different driving forces and speeds in crossing the obstacle 20. The cleaning robot 10 can cross obstacles 20 of different difficulties in different obstacle-crossing modes, which may improve the obstacle-crossing ability of the cleaning robot 10 and may ensure the obstacle-crossing success rate of the cleaning robot 10.

Next, three cases where the cleaning member 13 may be the rolling brush 131, may be the roller 132, or may comprise the rolling brush 131 and the roller 132 will be introduced separately.

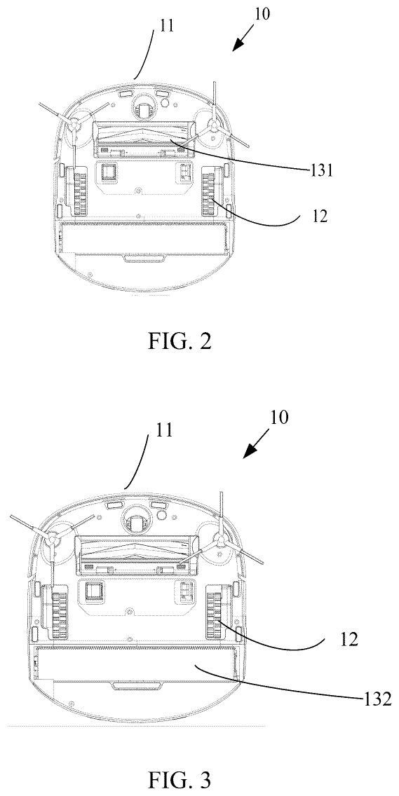

As shown in FIG. 2, the case where the cleaning member 13 may be the rolling brush 131 may be described in detail.

In the forward obstacle-crossing mode, the rolling brush 131 may rotate forward; and in the backward obstacle-crossing mode, the rolling brush 131 may rotate forward or reversely. Alternatively, in the forward obstacle-crossing mode, the rolling brush 131 may rotate reversely; and in the backward obstacle-crossing mode, the rolling brush 131 may rotate reversely.

During operation of the cleaning robot 10, since the cleaning robot 10 rolls the garbage into a cavity for holding the garbage through the forward rotation of the rolling brush 131, it may be easy to roll the garbage out of the cavity (spit the garbage) when the rolling brush 131 may rotate reversely. Therefore, the cleaning robot 10 may be usually adaptively provided with a relevant structure designed to prevent spitting of the garbage for the reverse rotation of the rolling brush 131.

Regarding the forward obstacle-crossing mode, the driving wheel 12 may rotate forward, and the rolling brush 131 can rotate forward or reversely. When the rolling brush 131 may rotate forward, a driving force of the cleaning robot 10 may comprise driving forces generated by rotations of the driving wheel 12 and the rolling brush 131. In this case, the driving force of the cleaning robot 10 may be strong, and the cleaning robot can cross obstacles of higher difficulty to cross. When the rolling brush 131 may rotate reversely, a driving force of the cleaning robot 10 may be a difference between the driving force of the driving wheel 12 and the driving force of the rolling brush 131. In this case, the driving force of the cleaning robot 10 may be weak, and the cleaning robot can cross obstacles of lower difficulty to cross.

Further, in the normal obstacle-crossing mode, the rolling brush 131 may rotate reversely; and in a strong obstacle-crossing mode, the rolling brush 131 may rotate forward.

In the backward obstacle-crossing mode, the driving wheel 12 may rotate reversely and the rolling brush 131 can rotate forward or reversely. When the rolling brush 131 may rotate forward, a driving force of the cleaning robot 10 may be a difference between the driving force of the driving wheel 12 and the driving force of the rolling brush 131. In this case, the driving force of the cleaning robot 10 may be weak, and the cleaning robot 10 can cross obstacles of lower difficulty to cross. When the rolling brush 131 may rotate reversely, a driving force of the cleaning robot 10 may comprise driving forces generated by rotations of the driving wheel 12 and the rolling brush 131. In this case, the driving force of the cleaning robot 10 may be strong, and the cleaning robot 10 can cross obstacles of higher difficulty to cross.

Next, the case where the cleaning member 13 may be the roller 132 may be described in detail. As shown in FIG. 3, in the forward obstacle-crossing mode, the roller 132 may rotate forward or reversely; and in the reverse obstacle-crossing mode, the roller 132 may rotate reversely.

For the forward obstacle-crossing mode, the driving wheel 12 may rotate forward, and the roller 132 can rotate forward or reversely. When the roller 132 may rotate forward, a driving force of the cleaning robot 10 may comprise driving forces generated by rotations of the driving wheel 12 and the roller 132. In this case, the driving force of the cleaning robot 10 may be strong, and the cleaning robot can cross obstacles of higher difficulty. When the roller 132 may rotate reversely, a driving force of the cleaning robot 10 may be difference between the driving force of the driving wheel 12 and the driving force of the roller 132. In this case, the driving force of the cleaning robot 10 may be weak, and the cleaning robot can cross obstacles of lower difficulty.

Further, in the normal obstacle-crossing mode, the roller 132 may rotate reversely; and in the strong obstacle-crossing mode, the roller 132 may rotate forward.

Regarding the backward obstacle-crossing mode, the driving wheel 12 may rotate reversely and the roller 132 may rotate reversely. A driving force of the cleaning robot 10 may comprise driving forces generated by rotations of the driving wheel 12 and the roller 132. In this case, the driving force of the cleaning robot 10 may be strong, and the cleaning robot can cross obstacles of higher difficulty.

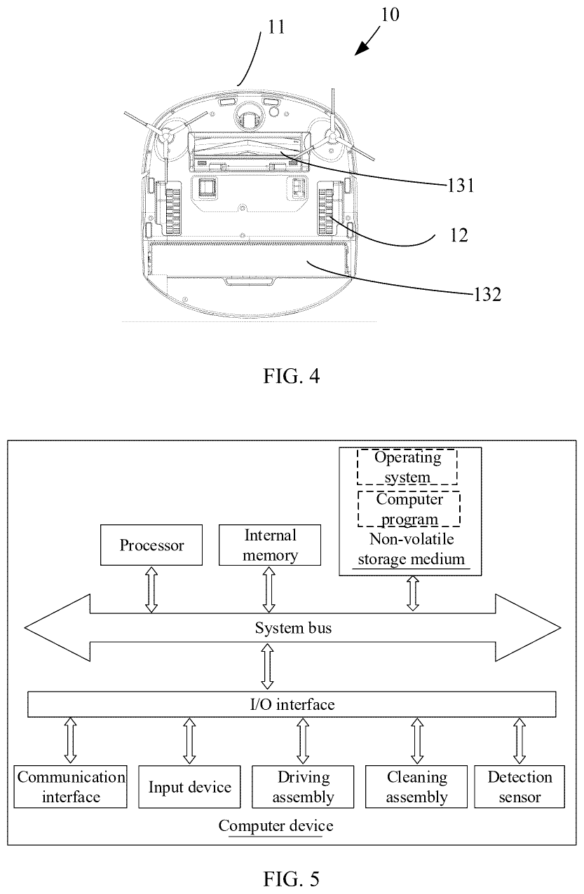

Finally, the case where the cleaning member 13 may comprise the rolling brush 131 and the roller 132 may be introduced in detail. As shown in FIG. 4, the cleaning member 13 may comprise the rolling brush 131 and the roller 132, and the number of forward rotations of the rolling brush 131 and the roller 132 in the strong obstacle-crossing mode may be greater than that in the normal obstacle-crossing mode.

In the case where the cleaning member 13 may comprise the rolling brush 131 and the roller 132, the number of rotating components may be three. If the number of forward rotations in the strong obstacle-crossing mode may be three, the number of forward rotations in the normal obstacle-crossing mode can be two or one. For example, in the strong obstacle-crossing mode, the driving wheel 12, the rolling brush 131 and the roller 132 all rotate forward. In the normal obstacle-crossing mode, the driving wheel 12 and one of the rolling brush 131 and the roller 132 rotate forward, or the driving wheel 12 may rotate forward and both the rolling brush 131 and the roller 132 rotate reversely.

If the number of forward rotations in the strong obstacle-crossing mode may be at least two, the number of forward rotations in the normal obstacle-crossing mode can be one. For example, in the strong obstacle-crossing mode, the driving wheel 12, the rolling brush 131 and the roller 132 all rotate forward, or the driving wheel 12 and one of the rolling brush 131 and the roller 132 rotate forward; and in the normal obstacle-crossing mode, the driving wheel 12 may rotate forward, and both the rolling brush 131 and the roller 132 rotate reversely.

The obstacle-crossing ability of the cleaning robot 10 in the strong obstacle-crossing mode may be greater than that in the normal obstacle-crossing mode, while obstacle-crossing ability in the backward obstacle-crossing mode varies from rotation directions of the driving wheel 12 and the cleaning member 13 in the respective modes. In some examples, the obstacle-crossing ability of the cleaning robot 10 in the backward obstacle-crossing mode may be between that in the normal obstacle-crossing mode and that in the strong obstacle-crossing mode.

The cleaning robot 10 further may comprise a processor 14, and the processor 14 may be separately connected with the driving wheel 12 and the cleaning member 13.

The processor 14 may be configured to output a control instruction to the driving wheel 12 and the cleaning member 13 according to a target obstacle-crossing mode. The target obstacle-crossing mode may comprise the backward obstacle-crossing mode or the forward obstacle-crossing mode, and the forward obstacle-crossing mode may comprise the normal obstacle-crossing mode and the strong obstacle-crossing mode. The number of forward rotations of the driving wheel 12 and the cleaning member 13 in the strong obstacle-crossing mode may be greater than that in the normal obstacle-crossing mode.

The driving wheel 12 and the cleaning member 13 may be configured to perform a rotation operation according to the control instruction.

When the cleaning robot 10 needs to cross the obstacle 20, the processor 14 in the cleaning robot 10 can determine difficulty of the cleaning robot 10 in crossing the obstacle 20 according to attribute information of the obstacle 20. Then, the processor may select an obstacle-crossing mode corresponding to the difficulty as the target obstacle-crossing mode based on the difficulty of the cleaning robot 10 in crossing the obstacle 20. For example, the strong obstacle-crossing mode can be used to cross an obstacle 20 of the highest difficulty, the backward obstacle-crossing mode can be used to cross an obstacle 20 of moderate difficulty, and the normal obstacle-crossing mode can be used to cross an obstacle 20 of the lowest difficulty. The attribute information may be one or more of height information, width information, shape information and sill number information of the obstacle 20.

As an example, the obstacle 20 may be a raised area (sill) or a sunken area in a working space of the cleaning robot 10. If the obstacle 20 may be the raised area, height information of the obstacle 20 can be height of the raising, width information of the obstacle 20 can be a width of a raised position, shape information of the obstacle 20 can be a raised shape of the raised position (for example, which can be round or square), and the sill number information of the obstacle 20 can be the number of raised positions in the raised area (for example, assuming that the obstacle 20 may be a sill of a sliding door, the sill number information can be the number of raised paths for sliding movement of the sliding door); and if the obstacle 20 may be the sunken area, the height information of the obstacle 20 can be a sunken depth, the width information of the obstacle 20 can be a sunken width of a sunken position, the shape information of the obstacle 20 can be a shape of the sunken position (for example, which can be round or square), and the sill number information of the obstacle 20 can be the number of sunken positions in the sunken area.

When the cleaning robot 10 needs to cross an obstacle 20, the processor 14 of the cleaning robot 10 may take an obstacle-crossing mode corresponding to the lowest difficulty as the target obstacle-crossing mode regardless of the obstacle 20 of which difficulty. When the crossing fails, the obstacle-crossing mode corresponding to the lowest difficulty may be switched to the obstacle-crossing mode corresponding to the moderate difficulty, and then the obstacle-crossing mode corresponding to the moderate difficulty may be taken as the target obstacle-crossing mode. If the crossing still fails on this basis, an obstacle-crossing mode corresponding to higher difficulty may be then switched until the cleaning robot 10 completes crossing of the obstacle 20. If the cleaning robot 10 does not cross the obstacle 20 in an obstacle-crossing mode corresponding to the highest difficulty, that failure may indicate that the obstacle 20 exceeds a crossing range of the cleaning robot 10. At this time, the cleaning robot 10 can be controlled to stop crossing.

After the processor 14 determines the target obstacle-crossing mode, a control instruction can be generated based on the target obstacle-crossing mode and sent to the driving wheel 12 and the cleaning member 13. The driving wheel 12 and the cleaning member 13 may perform a corresponding rotation operation based on the control instruction. For example, the target obstacle-crossing mode may be the forward obstacle-crossing mode, and both the driving wheel 12 and the cleaning member 13 perform a forward rotation operation, so that the head of the cleaning robot 10 faces the obstacle 20 and crosses an obstacle 20 of higher difficulty.

Next, specific content of selecting the target obstacle-crossing mode according to the attribute information may be introduced through an example. For example, the processor 14 may be further configured to select the target obstacle-crossing mode from pre-configured obstacle-crossing modes according to the attribute information of the obstacle 20. The pre-configured obstacle-crossing modes may include the backward obstacle-crossing mode, the normal obstacle-crossing mode and the strong obstacle-crossing mode.

A body of the cleaning robot 10 may be provided with a detection sensor by which the cleaning robot 10 can sense surrounding environment. The processor 14 can perform object detection on information such as images collected by the detection sensor, to determine whether there may be an obstacle 20 in front of the cleaning robot 10. If it is determined that there may be an obstacle 20, the collected information may be further analyzed to determine information such as the height information, width information, shape information and sill number information of the obstacle 20, and these pieces of information may be taken as the attribute information of the obstacle 20.

Additionally and/or alternatively, the processor 14 of the cleaning robot 10 can be connected with a detection sensor provided in a cleaning environment, such as an indoor monitoring camera, and the processor 14 can determine the attribute information of the obstacle 20 by analyzing an image collected by the detection sensor provided in the cleaning environment.

The detection sensor can be a radar, a camera and the like. The detection sensor may be provided on the body of the cleaning robot 10 and/or the detection sensor may be provided in the cleaning environment. The image collected by the detection sensor can be an image taken by a monocular camera, an image taken by a binocular camera, and a three-dimensional point cloud data measured by the radar. The processor 14 can detect whether there may be a target obstacle 20 to be crossed on a moving path of the cleaning robot 10 according to detection data. If the target obstacle 20 to be crossed by the cleaning robot 10 is detected, the attribute information of the target obstacle 20 may be identified according to the detection data of the detection sensor.

As an example, if the detection data may be detection data of the monocular camera, multiple frames of shot images of the monocular camera may be obtained; and it may be detected whether there may be an obstacle 20 to be crossed by the cleaning robot 10 by fusing multiple frames of shot images. In addition, it may be also possible to generate 3D point cloud data by three-dimensional reconstruction based on multiple frames of shot images through multi-view geometric mapping, so that the attribute information of the obstacle 20 can be detected according to the 3D point cloud data.

As an example, if the detection data may be detection data of the binocular camera, a frame of shot image of the binocular camera may be obtained; and it may be detected whether there may be an obstacle 20 to be crossed by the cleaning robot 10 through the frame of shot image. In addition, it may be also possible to generate 3D point cloud data by three-dimensional reconstruction based on the frame of shot image through multi-view geometric mapping, so that the attribute information of the obstacle 20 can be detected according to the 3D point cloud data.

As an example, if the detection data may be the three-dimensional point cloud data measured by the radar, it may be directly detected whether there may be an obstacle 20 to be crossed by the cleaning robot 10 and the attribute information of the obstacle 20 according to the three-dimensional point cloud data.

Furthermore, the cleaning robot 10 may be equipped with different obstacle-crossing modes, and obstacle-crossing ability and efficiency of different obstacle-crossing modes may be also different. The obstacle-crossing mode with stronger obstacle-crossing ability may have a higher obstacle-crossing efficiency. For example, in the strong obstacle-crossing mode, obstacle-crossing ability and efficiency of the cleaning robot 10 may be the highest. In the backward obstacle-crossing mode, obstacle-crossing ability and efficiency of the cleaning robot 10 may be lower. In the normal obstacle-crossing mode, the obstacle-crossing ability and efficiency of the cleaning robot 10 may be the lowest.

Therefore, in this example, it might be desirable to select an obstacle-crossing mode with higher obstacle-crossing efficiency as far as possible on a basis of selecting an obstacle-crossing mode with obstacle-crossing ability to overcome obstacle-crossing difficulty of the obstacle 20, so as to give consideration to both an obstacle-crossing success rate and the obstacle-crossing efficiency.

The cleaning robot 10 may have different obstacle-crossing abilities in different obstacle-crossing modes, for example, there may be a mapping relationship between the obstacle-crossing modes and the obstacle-crossing ability. Then, the processor 14 of the cleaning robot 10 can match the attribute information of the obstacle 20 with attribute information corresponding to different obstacle-crossing ability to determine obstacle-crossing ability required for the obstacle 20. Then, based on the obstacle-crossing ability required for the obstacle 20, a target obstacle-crossing mode matching the obstacle-crossing ability may be selected from the pre-configured obstacle-crossing modes.

As an example, the attribute information may comprise a height of the obstacle 20, and the attribute information corresponding to different obstacle-crossing ability may comprise two height thresholds. For example, an obstacle-crossing height of the strong obstacle-crossing mode can be 1 cm to 1.5 cm. An obstacle-crossing height of the backward obstacle-crossing mode can be 0.5 cm to 1 cm. An obstacle-crossing height of the normal obstacle-crossing mode can be less than 0.5 cm. Specific content of selecting the target obstacle-crossing mode from the pre-configured obstacle-crossing modes according to the attribute information of the obstacle 20 may comprise selecting the target obstacle-crossing mode from the different obstacle-crossing modes according to the height of the obstacle 20 and the two height thresholds.

The processor 14 of the cleaning robot 10 may be further configured to select the target obstacle-crossing mode from the pre-configured obstacle-crossing modes according to the attribute information of the obstacle 20. The pre-configured obstacle-crossing modes include the backward obstacle-crossing mode, the normal obstacle-crossing mode and the strong obstacle-crossing mode. A most suitable obstacle-crossing mode can be flexibly selected as the target obstacle-crossing mode according to the attribute information. On a basis of ensuring that the obstacle-crossing ability of the cleaning robot 10 in the selected target obstacle-crossing mode can overcome the obstacle-crossing difficulty of the obstacle 20, the obstacle-crossing mode with higher obstacle-crossing efficiency and without influence on the cleaning efficiency can be selected as far as possible, which can consider the obstacle-crossing success rate, obstacle-crossing efficiency and cleaning efficiency of the cleaning robot 10.

Discussion will now turn to specific content of determining the target obstacle-crossing mode. The processor 14 may be further configured to take the normal obstacle-crossing mode among the pre-configured obstacle-crossing modes as the target obstacle-crossing mode in a case where the attribute information meets information conditions corresponding to the normal obstacle-crossing mode; and take the backward obstacle-crossing mode or the strong obstacle-crossing mode as the target obstacle-crossing mode based on the attribute information and scenario complexity of an obstacle-crossing scenario where the cleaning robot 10 may be located in a case where the attribute information does not meet information conditions corresponding to the normal obstacle-crossing mode.

The scenario complexity may refer to complexity of an environment where the cleaning robot 10 crosses the obstacle 20, and usually relates to the obstacle 20 and at least one factor related to a proceeding path of the cleaning robot 10 to the obstacle 20. For example, with a higher obstacle 20, it can be considered that the scenario complexity may be higher, or if there may be more other obstacles 20 near the traveling path of the cleaning robot 10 to the obstacle 20, it can be considered that the scenario complexity may be higher.

In this example, the processor 14 can match the attribute information of the obstacle 20 with the information conditions corresponding to the normal obstacle-crossing mode, and determine whether the attribute information of the obstacle 20 meets the information conditions corresponding to the normal obstacle-crossing mode according to the matching result.

As an example, the attribute information may be a height of the obstacle 20, and the information conditions corresponding to the normal obstacle-crossing mode may be a first height threshold. Then, if the height of the obstacle 20 may be less than the first height threshold, it might indicate that the attribute information matches height conditions corresponding to the normal obstacle-crossing mode, and thus the normal obstacle-crossing mode can be selected as the target obstacle-crossing mode.

As an example, the attribute information may be a width of the obstacle 20, and the information conditions corresponding to the normal obstacle-crossing mode may be a first width threshold. If the width of the obstacle 20 may be less than the first width threshold, it might indicate that the attribute information matches a parameter of the first obstacle 20 corresponding to the normal obstacle-crossing mode, and thus the normal obstacle-crossing mode may be selected as the target obstacle-crossing mode.

When the attribute information of the obstacle 20 does not meet the information conditions corresponding to the normal obstacle-crossing mode, the processor 14 can determine obstacle-crossing difficulty of the cleaning robot 10 by considering the scenario complexity of the obstacle-crossing scenario where the cleaning robot 10 may be located and the attribute information of the obstacle 20. Based on the obstacle-crossing difficulty, the target obstacle-crossing mode may be selected from the backward obstacle-crossing mode and the strong obstacle-crossing mode.

If the scenario complexity of the obstacle-crossing scenario where the cleaning robot 10 may be located meets the preset conditions, it might indicate that the cleaning robot 10 may be able to cross the obstacle 20. In this case, the processor 14 may match the attribute information of the obstacle 20 with information conditions corresponding to the backward obstacle-crossing mode, and if the matching succeeds, the backward obstacle-crossing mode may be taken as the target obstacle-crossing mode; and if the matching does not succeed, the strong obstacle-crossing mode may be taken as the target obstacle-crossing mode. If the scenario complexity of the obstacle-crossing scenario where the cleaning robot 10 may be located does not meet preset conditions, it indicates that it may be difficult for the cleaning robot 10 to cross the obstacle 20. At this time, a user can remotely control the cleaning robot 10 to try to cross the obstacle.

The processor 14 of the cleaning robot 10 may be further configured to select the target obstacle-crossing mode from the pre-configured obstacle-crossing modes according to the attribute information of the obstacle 20. The pre-configured obstacle-crossing modes include the backward obstacle-crossing mode, the normal obstacle-crossing mode and the strong obstacle-crossing mode. The processor 14 can select a target obstacle-crossing mode that may be adapted to the obstacle 20 from different obstacle-crossing modes according to the attribute information. With a higher fit degree of the target obstacle-crossing mode to the obstacle 20, the cleaning robot 10 can be ensured to cross the obstacle 20 accurately and efficiently, with higher obstacle-crossing success rate and efficiency of the cleaner robot 10.

Next, a way to obtain the scenario complexity above may be introduced in detail through an example. The processor 14 may detect the height information, the width information, the shape information and the sill number information of the obstacle 20 and obstacle-crossing path information of the cleaning robot 10 according to a scenario image of the obstacle-crossing scenario; and may detect the scenario complexity of the obstacle-crossing scenario in which the cleaning robot 10 may be located according to the obstacle-crossing path information of the cleaning robot 10 and the height information, the width information, the shape information and the sill number information of the obstacle 20.

The scenario complexity may be usually related to features of the obstacle 20 itself and features of the obstacle-crossing path between the cleaning robot 10 and the obstacle 20. The features of the obstacle 20 itself can be the height, width, shape and sill number of the obstacle 20, and the features of the obstacle-crossing path can be a path length, path curvature and the number of obstacles 20 near the path.

As an example, the height, width, shape and sill number of the obstacle 20 may be detected separately by detecting the scenario image so as to obtain the height information, the width information, the shape information and the sill number information. By detecting the scenario image, a path length and path curvature of the obstacle-crossing path between the cleaning robot 10 and the obstacle 20 and the number of obstacles 20 near the obstacle-crossing path may be detected separately to obtain path length information, path curvature information and information about the number of adjacent obstacles 20. The path length information, the path curvature information and the information about the number of adjacent obstacles 20 may be combined as the obstacle-crossing path information.

For example, the obstacle-crossing path information of the cleaning robot 10 and the height information, the width information, the shape information, and/or the sill number information of the obstacle 20 may be merged to obtain scenario complexity detection information. Features of the scenario complexity detection information may be extracted to obtain scenario complexity features. The scenario complexity of the obstacle-crossing scenario in which the cleaning robot 10 may be located may be detected according to the scenario complexity features.

As an example, the scenario complexity features can be vector features, and the scenario complexity of the obstacle-crossing scenario in which the cleaning robot 10 may be located can be generated by fully connecting the scenario complexity features.

The processor 14 may detect the height information, the width information, the shape information and the sill number information of the obstacle 20 and the obstacle-crossing path information of the cleaning robot 10 according to a scenario image of the obstacle-crossing scenario; and may detect the scenario complexity of the obstacle-crossing scenario in which the cleaning robot 10 may be located according to the obstacle-crossing path information of the cleaning robot 10 and the height information, the width information, the shape information, and/or the sill number information of the obstacle 20. Comprehensively considering information such as the height, width, shape and sill number of the obstacles 20 and information such as the path length, the path curvature, and/or the number of obstacles 20 adjacent to the path, the scenario complexity of the obstacle-crossing scenario in which the cleaning robot 10 may be located may be detected, which provides a reliable basis for detection of the scenario complexity, and thus can improve detection accuracy of scenario complexity.

Discussion will now turn to cases where the scenario complexity meets the preset conditions and does not meet the preset conditions.

The case where the scenario complexity meets the preset conditions may be described through an example. The processor 14 of the cleaning robot 10 may be further configured to, in a case where the scenario complexity meets the preset conditions, take the backward obstacle-crossing mode as the target obstacle-crossing mode if the attribute information meets the information conditions corresponding to the backward obstacle-crossing mode; and take the strong obstacle-crossing mode as the target obstacle-crossing mode if the attribute information does not meet the information conditions corresponding to the backward obstacle-crossing mode.

In the example, if the scenario complexity meets the preset conditions, it indicates that the cleaning robot 10 may be not prone to collide in crossing the obstacle 20, and the cleaning robot 10 can select the obstacle-crossing mode independently. In this case, the processor 14 can match the attribute information of the obstacle 20 with the information conditions corresponding to the backward obstacle-crossing mode. If the matching may be successful, it indicates that the obstacle 20 may be of moderate difficulty to be crossed, and the backward obstacle-crossing mode can be taken as the target obstacle-crossing mode. If the matching may be not successful, it indicates that the obstacle 20 may be of higher difficulty to cross, and the strong obstacle-crossing mode can be taken as the target obstacle-crossing mode.

For example, height conditions corresponding to the backward obstacle-crossing mode may be 0.5 cm to 1 cm. If a height of the obstacle 20 may be 0.9 cm, the backward obstacle-crossing mode can be selected as the target obstacle-crossing mode. If the height of the obstacle 20 may be 1.3 cm, it may be necessary to select the strong obstacle-crossing mode as the target obstacle-crossing mode.

The sill number corresponding to the backward obstacle-crossing mode may be less than 3, and if the sill number of the obstacle 20 may be 2, the backward obstacle-crossing mode can be selected as the target obstacle-crossing mode. If the sill number of the obstacle 20 may be 4, it may be necessary to select the strong obstacle-crossing mode as the target obstacle-crossing mode.

The processor 14 may be further configured to, in a case where the scenario complexity meets the preset conditions, take the backward obstacle-crossing mode as the target obstacle-crossing mode if the attribute information meets the information conditions corresponding to the backward obstacle-crossing mode; and take the strong obstacle-crossing mode as the target obstacle-crossing mode if the attribute information does not meet the information conditions corresponding to the backward obstacle-crossing mode. In this way, when the scenario complexity may be low, the processor 14 can accurately determine which obstacle-crossing mode may be selected as the target obstacle-crossing mode based on a matching result of the attribute information of the obstacle 20 and the information conditions corresponding to the backward obstacle-crossing mode.

The case where the scenario complexity does not meet the preset conditions may be described through an example, and the processor 14 may be further configured to send a mode selection request to a terminal device in the case where the scenario complexity does not meet the preset conditions; and take the backward obstacle-crossing mode or the strong obstacle-crossing mode as the target obstacle-crossing mode based on a user's response information to the mode selection request.

In this example, if the scenario complexity does not meet the preset conditions, it may indicate that the cleaning robot 10 may be prone to collision in crossing the obstacle 20. At this time, a user might intervene, so that a mode selection request may be sent to the terminal device, response information of the terminal device based on the mode selection request may be received, and the backward obstacle-crossing mode or the strong obstacle-crossing mode may be taken as the target obstacle-crossing mode.

The mode selection request can be sent to the terminal device in a form of an application pop-up window, a short message, and/or a voice call, and the user can input relevant information for selecting the target obstacle-crossing mode on the terminal device by dragging, clicking, text input or voice input.

The processor 14 may be further configured to send the mode selection request to the terminal device when the scenario complexity does not meet the preset conditions; and take the backward obstacle-crossing mode or the strong obstacle-crossing mode as the target obstacle-crossing mode based on a user's response information to the mode selection request. When the scenario complexity is high, the user intervenes in assist the cleaning robot 10 in accurately determining which obstacle-crossing mode may be selected as the target obstacle-crossing mode, thus improving selection accuracy of the obstacle-crossing mode.

The above examples may be all processes of determining the target obstacle-crossing mode based on the attribute information of the obstacle 20. The cleaning robot 10 can also try to cross obstacles in an order of obstacle-crossing ability from small to large.

Discussion will now turn to a process of trying to cross obstacles many times.

The processor 14 may be further configured to obtain the number of consecutive failures in obstacle-crossing of the cleaning robot 10 during a process in which the cleaning robot 10 crosses the obstacle 20 in the normal obstacle-crossing mode; take the backward obstacle-crossing mode or the strong obstacle-crossing mode as a new target obstacle-crossing mode if the number of consecutive failures in obstacle crossing may be greater than a first failure number threshold; and control the cleaning robot 10 to cross the obstacle 20 in the new target obstacle-crossing mode.

The cleaning robot 10 may take the normal obstacle-crossing mode as a default obstacle-crossing mode. When there may be an obstacle 20 ahead, the cleaning robot 10 might not need to to identify the attribute information of the obstacle 20, and may directly cross the obstacle 20 in the default obstacle-crossing mode. It should be noted that the cleaning robot 10 can also set a failure number threshold in the default obstacle-crossing mode. In the default obstacle-crossing mode, if the cleaning robot 10 can cross the obstacle 20 within a range of the failure number threshold, it indicates that the obstacle 20 may be of lower crossing difficulty. For example, the failure number threshold in the default obstacle-crossing mode can be 3, 4, 6, etc.

In the default obstacle-crossing mode, if the cleaning robot 10 cannot cross the obstacle 20 within a range of the failure number threshold, that may indicate that the obstacle 20 may be of higher crossing difficulty, and it may be necessary to select an obstacle-crossing mode with stronger obstacle-crossing ability as the target obstacle-crossing mode.

Further, if the cleaning robot 10 does not cross the obstacle 20 in the default obstacle-crossing mode, it may be desirable to select one of the backward obstacle-crossing mode and the strong obstacle-crossing mode as a new target obstacle-crossing mode. In the new target obstacle-crossing mode, the processor 14 may control the cleaning robot 10 to cross the obstacle 20.

It can be understood that the normal obstacle-crossing mode has weakest obstacle-crossing ability, the backward obstacle-crossing mode has moderate obstacle-crossing ability, and the strong obstacle-crossing mode has strongest obstacle-crossing ability. Therefore, the processor 14 can use the normal obstacle-crossing mode, the backward obstacle-crossing mode and the strong obstacle-crossing mode in an order of the obstacle-crossing ability until the cleaning robot 10 crosses the obstacle 20.

The processor 14 of the cleaning robot 10 above may be further configured to obtain the number of consecutive failures in obstacle-crossing of the cleaning robot 10 during the process in which the cleaning robot 10 crosses the obstacle 20 in the normal obstacle-crossing mode; take the backward obstacle-crossing mode or the strong obstacle-crossing mode as the new target obstacle-crossing mode if the number of consecutive failures in obstacle-crossing may be greater than the first failure number threshold; and control the cleaning robot 10 to cross the obstacle 20 in the new target obstacle-crossing mode. During a process in which the cleaning robot 10 crosses the obstacle 20, the normal obstacle-crossing mode may be taken as the default obstacle-crossing mode, so that the cleaning robot 10 can cross most of obstacles 20. For other obstacles 20 that may be difficult to be crossed, an obstacle-crossing mode of higher difficulty may be selected for crossing, which avoids frequent switching of the rotation directions of the driving wheel 12 and the cleaning member 13 and saves obstacle-crossing cost.

The cleaning robot 10 uses multiple obstacle-crossing modes to try to cross the obstacle, and if the obstacle-crossing mode with the strongest obstacle-crossing ability still fails, it indicates that a probability that the cleaning robot 10 crosses the obstacle 20 may be small. At this time, the cleaning robot 10 can be controlled to be in a standby state, so as to avoid damage of the cleaning robot 10 caused by repeated attempts to cross obstacles. the processor 14 may be further configured to obtain the number of consecutive failures in obstacle-crossing of the cleaning robot 10 in the obstacle-crossing mode with the strongest obstacle-crossing ability. If the number of consecutive failures is greater than a second failure number threshold, the cleaning robot 10 may be controlled to enter the standby state and send an obstacle-crossing failure message. Of course, this method also applies to matching a corresponding target obstacle-crossing mode based on the attribute information of the obstacle 20 and the scenario complexity of the obstacle-crossing scenario in which the cleaning robot 10 may be located. If the obstacle-crossing mode with the strongest obstacle-crossing ability may be matched based on the attribute information of the obstacle 20 and the scenario complexity of the obstacle-crossing scenario in which the cleaning robot 10 may be located, and the number of consecutive failures in obstacle-crossing of the cleaning robot 10 in this strongest obstacle-crossing mode may be greater than the second failure number, the cleaning robot 10 may be controlled to enter the standby state and send an obstacle-crossing failure message.

The failure number threshold corresponding to the multiple obstacle-crossing modes of the cleaning robot 10 can be set in advance, and the failure number thresholds corresponding to different obstacle-crossing modes can be the same or different. For example, the failure number threshold corresponding to the normal obstacle-crossing mode can be 5, the failure number threshold corresponding to the backward obstacle-crossing mode can be 3, and a failure number threshold corresponding to the strong obstacle-crossing mode can be 2.

During a process in which the cleaning robot 10 crosses in the obstacle-crossing mode (i.e., the strong obstacle-crossing mode) with the strongest obstacle-crossing ability, the processor 14 can obtain the number of consecutive failures of obstacle-crossing. When the number of continuous failures in obstacle-crossing may be greater than the second failure number threshold, it indicates that the probability that the cleaning robot 10 crosses the obstacle 20 may be small. At this time, the processor 14 can send a stop command to the driving wheel 12 and the cleaning member 13. After receiving the stop command, the driving wheel 12 and the cleaning member 13 may stop rotating, and the cleaning robot 10 enters the standby state. Meanwhile, the processor 14 can also send the obstacle-crossing failure message to a remote client; or, the processor 14 can control a voice device on the cleaning robot 10 to output an obstacle-crossing failure reminder message.

The processor 14 of the cleaning robot 10 may be further configured to obtain the number of consecutive failures of the cleaning robot 10 in crossing an obstacle in an obstacle-crossing mode with the strongest obstacle-crossing ability. If the number of consecutive failures may be greater than a second failure number threshold, the cleaning robot 10 may be controlled to enter the standby state and send an obstacle-crossing failure message. In this way, it may be possible to prevent the cleaning robot 10 from being damaged due to continuous crossing with a low obstacle-crossing success rate, and remind the user in time that the cleaning robot 10 has failed in obstacle-crossing.

The obstacle-crossing ability of the cleaning robot 10 in the multiple obstacle-crossing modes can be updated based on performance of the cleaning robot 10 in an actual obstacle-crossing process, so that the cleaning robot 10 can more accurately cross the obstacle 20. Then, the processor 14 may be further configured to calculate an obstacle-crossing failure probability in a pre-configured obstacle-crossing mode according to the number of consecutive failures in obstacle-crossing of the cleaning robot 10. Information conditions corresponding to the pre-configured obstacle-crossing mode may be updated according to the obstacle-crossing failure probability. The information conditions corresponding to the pre-configured obstacle-crossing mode may be configured to characterize obstacle-crossing ability of the cleaning robot 10 in different obstacle-crossing modes.

In the example, for any of the obstacle-crossing modes, if the cleaning robot 10 fails to cross the obstacle in this obstacle-crossing mode, a total number of obstacle-crossings and the number of consecutive failures of obstacle-crossing may be obtained, and a ratio of the number of consecutive failures of obstacle-crossing to the total number of obstacle-crossings may be calculated, and this ratio may be taken as an obstacle-crossing failure probability in this obstacle-crossing mode.

The processor 14 may compare the obstacle-crossing failure probability with a preset failure probability threshold, and if the obstacle-crossing failure probability may be greater than the preset failure probability threshold, it indicates that setting of the information conditions corresponding to the pre-configured obstacle-crossing mode may be not reasonable. At this time, it may be necessary to reduce the information conditions corresponding to the pre-configured obstacle-crossing mode. For example, a height in the information conditions corresponding to the normal obstacle-crossing mode may be 5 cm, and the failure probability of the cleaning robot 10 in the normal obstacle-crossing mode reaches 80%. At this time, the height in the information conditions corresponding to the normal obstacle-crossing mode can be adjusted to 3 cm.

The processor 14 of the cleaning robot 10 may be further configured to calculate the obstacle-crossing failure probability in the pre-configured obstacle-crossing mode according to the number of consecutive failures in obstacle-crossing of the cleaning robot 10. The information conditions corresponding to the pre-configured obstacle-crossing mode may be updated according to the obstacle-crossing failure probability. The information conditions corresponding to the pre-configured obstacle-crossing mode may be configured to characterize the obstacle-crossing ability of the cleaning robot 10 in different obstacle-crossing modes. For each of the obstacle-crossing modes, the obstacle-crossing failure probability in the obstacle-crossing mode can be updated in real time, and information conditions corresponding to the obstacle-crossing mode can be continuously fed back and adjusted according to the obstacle-crossing failure probability in the obstacle-crossing mode, so that the information conditions corresponding to the obstacle-crossing mode may be more and more accurate, which facilitates improving the accuracy of the cleaning robot 10 in selecting the target obstacle-crossing mode.

When the cleaning robot 10 does not successfully cross the obstacle in the obstacle-crossing mode with the strongest obstacle-crossing ability (i.e., the strong obstacle-crossing mode), it may be necessary for the user to decide whether to continue obstacle crossing. Then, the processor 14 above may be further configured to send an obstacle-crossing request when the cleaning robot 10 fails to cross the obstacle 20 in the obstacle-crossing mode with the strongest obstacle-crossing ability and receive request response information fed back based on the obstacle-crossing request. According to the request response information, the cleaning robot 10 may be controlled to cross the obstacle 20 according to the obstacle-crossing mode with the strongest obstacle crossing ability, or the cleaning robot 10 may be controlled to enter the standby state. The obstacle-crossing request can be sent by an APP pop-up reminder, short message, or voice call.

When the cleaning robot 10 does not successfully cross the obstacle in the strong obstacle-crossing mode, the processor 14 may send the obstacle crossing request to the remote user terminal. The user can determine whether to continue obstacle crossing based on an actual obstacle-crossing situation. If the user determines to continue obstacle crossing, a request response message may be fed back to the processor 14, which may be configured to control the cleaning robot 10 to continue obstacle crossing in the strong obstacle-crossing mode. If the user determines to stop obstacle crossing, a request response message may be fed back to the processor 14, which may be configured to control the cleaning robot 10 to enter the standby state.

When the user and the cleaning robot 10 may be in a same cleaning space, the cleaning robot 10 can also output a voice prompt message through its own voice device. For example, the voice prompt message can be “obstacle crossing failed, please confirm whether to continue obstacle crossing.” If the processor 14 of the cleaning robot 10 receives a user's obstacle-crossing confirmation message, the cleaning robot 10 may be controlled to continue obstacle crossing in the strong obstacle-crossing mode. If the processor 14 does not receive the user's obstacle-crossing confirmation message or receives a user's obstacle-crossing stop message, the cleaning robot 10 may be controlled to enter the standby state.

The processor 14 may be further configured to send the obstacle-crossing request in a case where the cleaning robot 10 fails to cross the obstacle 20 in the obstacle-crossing mode with the strongest obstacle-crossing ability and receive request response information fed back based on the obstacle-crossing request. According to the request response information, the cleaning robot 10 may be controlled to cross the obstacle 20 in the obstacle-crossing mode with the strongest obstacle crossing ability, or the cleaning robot 10 may be controlled to enter the standby state. In a case where the cleaning robot 10 still cannot cross the obstacle 20 in the strong obstacle-crossing mode, any of the elements described herein (e.g., the processor 14) may determine whether to continue obstacle crossing or stop obstacle crossing through a user's instruction, so as to avoid the cleaning robot 10 from being damaged due to continuous obstacle crossing with a low obstacle-crossing success rate.

The user information (including but not limited to user device information, user's personal information, etc.) and data (including but not limited to data for analysis, data for storage, data for display, etc.) involved in this disclosure may be all information and data authorized by the user or fully authorized by all parties, and collection, use and processing of relevant data need to comply with relevant regulations.

In an example, a computer device may be provided, which may be a server and may have an internal structure diagram as shown in FIG. 5. The computer device may comprise a processor, a memory, an input/output interface (abbreviated as I/O), and/or a communication interface. The processor, the memory and/or the input/output interface may be connected through a system bus, and the communication interface may be connected to the system bus through the input/output interface. The processor of the computer device may be configured to provide computing and control capabilities. The memory of the computer device may comprise a nonvolatile storage medium and an internal memory. The nonvolatile storage medium may store an operating system, a computer program and a database. The internal memory provides an environment for execution of the operating system and the computer program in the nonvolatile storage medium. The database of the computer device may be configured to store data during an obstacle-crossing process of the cleaning robot. The input/output interface of the computer device may be configured to exchange information between the processor and external devices. The communication interface of the computer device may be configured to communicate with external terminals through network connection. The compute program, when executed by the processor, implements a method for the cleaning robot to cross obstacles.

The structure shown in FIG. 5 is only a block diagram of a part of the structure related to the solution of the present disclosure, and does not constitute a limitation of the computer device to which the solution of the present disclosure may be applied. The specific computer device may include more or less components than those shown in the figure, or incorporate some components, or have different arrangements of components.

Those of ordinary skill in the art will appreciate that all or part of the processes in the method of the above examples can be implemented by instructing related hardware by a computer program stored in a non-volatile computer-readable storage medium, and when executed, the computer program can include the processes of the method examples. Any reference to memory, database, or other medium used in the examples of the present disclosure may include at least one of non-volatile memory and volatile memory. The non-volatile memory may include Read-Only Memory (ROM), a magnetic tape, a floppy disk, flash memory, optical memory, high-density embedded non-volatile memory, resistive variable memory (ReRAM), Magnetoresistive Random Access Memory (MRAM), Ferroelectric Random Access Memory (FRAM), Phase Change Memory (PCM), and Graphene memory, etc. The volatile memory may include Random Access Memory (RAM), external cache memory, or the like. By way of illustration and not limitation, the RAM may take various forms, such as Static Random Access Memory (SRAM) or Dynamic Random Access Memory (DRAM), and the like. The database according to the examples provided in the present disclosure may include at least one of a relational database and a non-relational database. The non-relational database may include a block chain-based distributed database or the like, but may be not limited thereto. The processor according to the examples provided in the present disclosure may be a general-purpose processor, a central processing unit, a graphics processor, a digital signal processor, a programmable logic unit, a data processing logic unit based on quantum computing, an artificial intelligence (AI) processor, or the like, but may be not limited thereto.

The technical features in the above examples may be combined arbitrarily. Not all possible combinations of the technical features in the above examples are described for the purposes of brevity.

The examples described above only express several implementations of the present disclosure, and the description thereof may be relatively specific and detailed, but should not be construed as limiting the scope of the present disclosure. Countless modifications and improvements can be made without departing from the concept of the present disclosure, and these may be all within the protection scope of the present disclosure. Therefore, the protection scope of the present disclosure should be subject to the appended claims.

What is claimed is:

1. A cleaning robot having at least a backward obstacle-crossing mode and a forward obstacle-crossing mode, the cleaning robot comprising:
a body,
a driving wheel, and
a cleaning member,
wherein both the driving wheel and the cleaning member are installed on the body and are rotatably connected with the body,
wherein a rotating shaft of the driving wheel is parallel to a rotating shaft of the cleaning member,
wherein, in the forward obstacle-crossing mode, a head of the cleaning robot faces an obstacle, the driving wheel rotates forward, and the cleaning member rotates in a first direction which is the same as or opposite to a rotation direction of the driving wheel; and
wherein, in the backward obstacle-crossing mode, a tail of the cleaning robot faces the obstacle, the driving wheel rotates reversely, and a rotation direction of the cleaning member is the same as or opposite to the rotation direction of the cleaning member in the forward obstacle-crossing mode.

2. The cleaning robot of claim 1, wherein the cleaning member comprises a rolling brush configured for dry cleaning of a working surface, and
either:
in the forward obstacle-crossing mode, the rolling brush rotates forward, and, in the backward obstacle-crossing mode, the rolling brush rotates forward or reversely; or
in the forward obstacle-crossing mode, the rolling brush rotates reversely, and, in the backward obstacle-crossing mode, the rolling brush rotates reversely.

3. The cleaning robot of claim 1, wherein the cleaning member comprises a roller configured for wet cleaning of a surface, and wherein, in the forward obstacle-crossing mode, the roller rotates forward or reversely, and wherein, in the backward obstacle-crossing mode, the roller rotates reversely.

4. The cleaning robot of claim 1,
wherein the forward obstacle-crossing mode comprises a normal obstacle-crossing mode and a strong obstacle-crossing mode;
wherein the cleaning member comprises one or more of:
a rolling brush configured for dry cleaning of one or more surfaces, or
a roller configured for wet cleaning of one or more surfaces; and
wherein, in the normal obstacle-crossing mode, the cleaning member rotates reversely, and, in the strong obstacle-crossing mode, the cleaning member rotates forward.

5. The cleaning robot of claim 4, wherein the cleaning member comprises both the rolling brush and the roller, and wherein a number of forward rotations of the rolling brush and the roller in the strong obstacle-crossing mode is greater than a number of forward rotations thereof in the normal obstacle-crossing mode.

6. The cleaning robot of claim 1, wherein the cleaning robot further comprises:
a processor separately connected with the driving wheel and the cleaning member,
wherein the processor is configured to output a control instruction to the driving wheel and the cleaning member according to a target obstacle-crossing mode;
wherein the target obstacle-crossing mode comprises the backward obstacle-crossing mode or the forward obstacle-crossing mode;
wherein the forward obstacle-crossing mode comprises a normal obstacle-crossing mode and a strong obstacle-crossing mode;
wherein a number of forward rotations of the driving wheel and the cleaning member in the strong obstacle-crossing mode is greater than that in the normal obstacle-crossing mode; and
wherein the driving wheel and the cleaning member are configured to perform a rotation operation according to the control instruction.

7. The cleaning robot of claim 6,
wherein the processor is further configured to select the target obstacle-crossing mode from pre-configured obstacle-crossing modes according to attribute information of the obstacle; and
wherein the pre-configured obstacle-crossing modes comprising the backward obstacle-crossing mode, the normal obstacle-crossing mode and the strong obstacle-crossing mode.

8. The cleaning robot of claim 7, wherein the processor is further configured to:
in a case where the attribute information meets information conditions corresponding to the normal obstacle-crossing mode, select the normal obstacle-crossing mode among the pre-configured obstacle-crossing modes as the target obstacle-crossing mode; and
in a case where the attribute information does not meet information conditions corresponding to the normal obstacle-crossing mode, select, based on the attribute information and complexity of an obstacle, the backward obstacle-crossing mode or the strong obstacle-crossing mode as the target obstacle-crossing mode.

9. The cleaning robot of claim 8, wherein the processor is further configured to, in a case where the complexity of the obstacle meets preset conditions:
when the attribute information meets information conditions corresponding to the backward obstacle-crossing mode, take the backward obstacle-crossing mode as the target obstacle-crossing mode;
when the attribute information does not meet information conditions corresponding to the backward obstacle-crossing mode, take the strong obstacle-crossing mode as the target obstacle-crossing mode;
in a case where the complexity of the obstacle does not meet preset conditions, send a mode selection request to a terminal device; and
select, based on a user's response information to the mode selection request, the backward obstacle-crossing mode or the strong obstacle-crossing mode as the target obstacle-crossing mode.

10. The cleaning robot of claim 6, wherein the strong obstacle-crossing mode involves a greater force of travel than the normal obstacle-crossing mode, and wherein the backward obstacle-crossing mode comprises an intermediate force of travel that is greater than a force of travel corresponding to the normal obstacle-crossing mode and the greater force of travel of the strong obstacle-crossing mode.

11. The cleaning robot of claim 6, wherein the processor is further configured to:
obtain, during a process in which the cleaning robot crosses the obstacle in the normal obstacle-crossing mode, a number of consecutive failures in obstacle-crossing of the cleaning robot;
based on determining that the number of consecutive failures in obstacle crossing is greater than a first failure number threshold, select the backward obstacle-crossing mode or the strong obstacle-crossing mode as a new target obstacle-crossing mode; and
control the cleaning robot to cross the obstacle in the new target obstacle-crossing mode.

12. The cleaning robot of claim 6, wherein the processor is further configured to:
obtain a number of consecutive failures of the cleaning robot in crossing an obstacle in an obstacle-crossing mode with the strongest obstacle-crossing ability; and
based on determining that the number of consecutive failures is greater than a second failure number threshold, control the cleaning robot to enter a standby state and send an obstacle-crossing failure message.

13. The cleaning robot of claim 6, wherein the processor is further configured to:
calculate, based on a number of consecutive failures in obstacle-crossing of the cleaning robot, an obstacle-crossing failure probability in a pre-configured obstacle-crossing mode according; and
update information conditions corresponding to the pre-configured obstacle-crossing mode according to the obstacle-crossing failure probability, wherein the information conditions corresponding to the pre-configured obstacle-crossing mode are configured to characterize an obstacle-crossing ability of the cleaning robot in different obstacle-crossing modes.

14. The cleaning robot of claim 6, wherein the processor is further configured to:
in a case where the cleaning robot fails to cross an obstacle in an obstacle-crossing mode with strongest obstacle-crossing ability:
send an obstacle-crossing request;
receive, based on the obstacle-crossing request, request response information fed back; and
based on the request response information, one of:
control the cleaning robot to cross the obstacle in the obstacle-crossing mode with the strongest obstacle crossing ability; or
control the cleaning robot to enter a standby state.

15. A cleaning robot having at least a backward obstacle-crossing mode and a forward obstacle-crossing mode, the cleaning robot comprising:
a driving wheel, and
a cleaning member,
wherein, in the forward obstacle-crossing mode, a head of the cleaning robot faces an obstacle, the driving wheel rotates forward, and the cleaning member rotates in a first direction which is the same as or opposite to a rotation direction of the driving wheel; and
wherein, in the backward obstacle-crossing mode, a tail of the cleaning robot faces the obstacle, the driving wheel rotates reversely, and a rotation direction of the cleaning member is the same as or opposite to the rotation direction of the cleaning member in the forward obstacle-crossing mode.

16. The cleaning robot of claim 15, wherein, in the forward obstacle-crossing mode, the cleaning member rotates forward, and, in the backward obstacle-crossing mode, the cleaning member rotates forward or reversely.

17. The cleaning robot of claim 15, wherein, in the forward obstacle-crossing mode, the cleaning member rotates reversely, and, in the backward obstacle-crossing mode, the cleaning member rotates reversely.

18. The cleaning robot of claim 15, wherein the forward obstacle-crossing mode comprises:
a normal obstacle-crossing mode wherein the cleaning member rotates reversely, and
a strong obstacle-crossing mode wherein the cleaning member rotates forward.

19. A method of navigating a cleaning robot around different obstacles, the method comprising:
based on a first size of a first obstacle in a cleaning path of the cleaning robot, causing the cleaning robot to enter into a forward obstacle-crossing mode, wherein, in the forward obstacle-crossing mode, a head of the cleaning robot faces the first obstacle, a driving wheel of the cleaning robot rotates forward, and a cleaning member of the cleaning robot rotates in a direction the same as or opposite to the rotation direction of the driving wheel; and
based on a second size of a second obstacle in the cleaning path of the cleaning robot, causing the cleaning robot to enter into a backward obstacle-crossing mode, wherein, in the backward obstacle-crossing mode, a tail of the cleaning robot faces the obstacle, the driving wheel rotates reversely, and a rotation direction of the cleaning member is the same as or opposite to the rotation direction of the cleaning member in the forward obstacle-crossing mode.

20. The method of claim 19, wherein the first size and second size are different.
